(19) United States
(12) Patent Application Publication
(10) Pub. No.: US 2002/0096560 A1
(43) Pub. Date: Jul. 25, 2002

(54) Postage stamp voting method in elections

(76) Inventor: John S. Page, Lake Forest, CA (US)

Correspondence Address: JOHN S. PAGE, JR., 15 REDBUD, RANCHO SANTA MARGARITA, CA, 92688, US

(21) Appl. No.: 09/766,446

(22) Filed: Jan. 20, 2001

(51) Int. Cl. G06C 23/00

(52) U.S. Cl. 235/51

(57) ABSTRACT

In elections, the method and means of recording the votes of voters onto material that can be processed through Postal Service machinery to read, sort and count said votes for the electorate, whereby said method and means includes the use of special labels to identify candidates, whereby said labels are used to be fixed on voting cards to indicate a voter's choice of candidate or measure, whereby said labels are self stick labels presented on a sheet or in a booklet. A roster of candidates and measures or sample ballot will be in each voting booth for the voters to refer to. It lists all the candidates and issues. When the voters look at the list of candidates and find the candidate they want to vote for they pull off the label of their choice from the booklet of labels and stick it on a blank voting card. That completes the vote for that office. When they have finished the voting, they allow said cards to be collected and sent to selected Post Offices.

### BACKGROUND OF INVENTION

This invention relates to the problem that the United States just experienced in the November 2000 election. Everyone knows there are too many vote counting machines that are inaccurate and ballots that are confusing. The estimated cost of putting high tech equipment in all the voting places around the United States is estimated to be 2.8 billion dollars.

### PRIOR ART

There is no prior art that applicant knows of that even remotely relates to applicants method because the Postal Office machines have not been made available for reading sorting and counting voted ballots. Sorting of Color-coded voting cards is also unknown to applicant. Colors help voters identify their choice of candidates and they also help political observer's track the cards or ballots during the sorting and counting process. Applicant's method has not been used in any election process that applicant is aware of.

### OBJECTS AND ADVANTAGES

The object of applicant's METHOD is to provide a more accurate system of casting, sorting and counting votes during the election process. One that is so accurate that no hand counts would ever be considered and there would be absolutely no doubt about the results.

The applicant discloses a METHOD for counting votes utilizing the high tech Postal Service machines that our nation and that other democratic nations already have in their Postal Service. These machines weigh each piece of mail, read the address and sort it according to zip code and bar code. They are very sophisticated, expensive machines and extremely accurate.

This is the tremendous advantage of applicant's METHOD and should be made available for voting in National elections and for National offices as well as state elections. The savings in capital outlay to upgrade our system will be tremendous in light of the estimates of 2.8 billion to do so.

The Federal Government can make deals with the States regarding processing their votes.

### OPERATION OF THE METHOD

There are a number of procedures that are possible to use in the casting and recording the votes of voters and making them workable and presentable in order to implement the applicant's METHOD of utilizing Post Office equipment to read, sort and count the votes of voters in elections. One of such procedures or methods is presented herein.

Each candidate or measure will have a code assigned to them. It will be printed on a self-sticking label along with his name. This code will identify the Candidates' and it is the means that the voters use to cast and communicate who they are voting for.

A roster of candidates and measures or sample ballot will be in each voting booth for the voters to refer to. It lists all the candidates and issues. When the voters look at the list of candidates and find the candidate they want to vote for they pull off the label of their choice from the booklet of labels and stick it on a blank voting card. That completes the vote for that office. They then move to the next office and repeat the process. When all the issues are voted on, by this method, the cards that represent the voter's selections are given back to the voting official for deposit in the collection box.

Because the office of the President is so important, the observation of the process of collecting and counting the votes for this office justifies a little different method, but just for the two most popular parties, the Republicans and Democrats and only for the office of President. The Republicans can have a special blue colored card that just has a bar code and the name REPUBLICAN printed on it. The Democrats can have a red colored card that has a bar code and the word DEMOCRAT printed on it. These can be permanent cards used over and over for many years because they do not designate a personal code only the party affiliation.

If the voter wants to vote for one of these two parties, they just select one of the cards as their vote for President and turn it in with the rest of their votes. Using the colored cards would allow the political party watchdogs to easily observe that the correct cards are being sorted into the correct hampers at the Post Office. This should give extra assurance to everyone that no mischief has occurred or is possible because it will be so visible and it will be unlikely that observers is will call blue cards red or visa versa. If a voter wants to vote for one of the other presidential candidates, they would select that candidate's label and stick it on a plain card just as they do on all the other candidates and measures.

### SUMMARY

Most of the 2.8 billions dollars that it is estimated to cost for purchasing new voting equipment can be saved by utilizing the Postal Services machines.

The above-described METHODS are very simple and they incorporate things that people of all ages are familiar with, such as placing labels or stamps on cards and letters.

The applicant believes this METHOD of combining and incorporating special coded cards to be used at the voting places and then counted or sorted on the machinery at Post Offices is a unique invention that provides an unexpected result that easily solves a well recognized and important National problem and meets a desperate need for accurately counting votes.

Applicant's suggested procedures or method of recording the votes of voters does not imply any limitation to the ways and means that could be used to accomplish the results that applicant's method does so effectively by incorporating the efficiency of the postal service machinery that reads, sorts and counts.

The above-described Methods are very simple and they incorporate things that people of all ages are familiar with, such as placing labels or stamps on cards and letters.

The applicant believes this METHOD of combining and incorporating special coded cards to be used at the voting places and then counted or sorted on the machinery at Post Offices is a unique invention that provides an unexpected result that easily solves a well recognized and important National problem and meets a desperate need for accurately counting votes.

Applicant's suggested procedures or METHOD of recording the votes of voters does not imply any limitation to the ways and means that could be used to accomplish the results that applicant's METHOD does so effectively by incorporating the efficiency of the Postal Service machinery that reads, sorts and counts.

1. In elections, the method and means of recording the votes of voters onto material that can be processed through Postal Service machinery to read, sort and count said votes for the electorate.

2. The claim of claim 1 whereby said method and means includes the use of special labels to identify candidates.

3. The claim of claim 2 whereby said labels are used to be fixed on voting cards to indicate a voter's choice of candidate or measure.

4. The claim of claim 2, whereby said labels are self stick labels presented on a sheet or in a booklet.

5. The claim of claim 1, whereby laws or measures or political offices or candidates running for offices are assigned a code, whereby said code and or said candidates name and or identification is printed on labels for the voters use to cast their vote, whereby when said voters go to voting places, they are given cards to cast their votes on, whereby said voters look at a roster or sample ballot and selects who or what they want to vote for and then pulls off a label that identifies the measure or candidate of their choice and fixes said label on one of said cards they were given, whereby when they have finished their voting, they allow said cards to be collected and sent to selected Post Offices.
